(19) United States
(12) Patent Application Publication
(10) Pub. No.: US 2016/0349995 A1
(43) Pub. Date: Dec. 1, 2016

(54) SYNCHRONIZING PER-CPU DATA ACCESS USING PER SOCKET RW-SPINLOCKS

(71) Applicants: Vinay VENUGOPAL, Bangalore, Karnataka (IN); Sherin Thyil GEORGE, Bangalore, Karnataka (IN); HEWLETT-PACKARD DEVELOPMENT COMPANY, L.P., Houston, TX (US)

(72) Inventors: Vinay VENUGOPAL, Bangalore (IN); T. George SHERIN, Bangalore (IN)

(21) Appl. No.: 15/115,005

(22) PCT Filed: Jan. 29, 2014
(86) PCT No.: PCT/IN2014/000070

§ 371 Date: Jul. 28, 2016

(51) Int. Cl. G06F 3/06

(52) U.S. Cl. CPC G06F 3/061; G06F 3/0658; G06F 3/0673

(57) ABSTRACT

Techniques for synchronizing per-central processing unit (per-CPU) data a using per socket reader-writer spinlocks (RW-spinlocks) are disclosed. In an example implementation, a RW-spinlock is allocated for each socket in a corresponding socket local memory (SLM) in a non-uniform memory access (NUMA) system. In this example implementation, each socket includes one or multiple CPUs and the CPUs in each socket are communicatively coupled to the corresponding SLM. Further, per-CPU data access between the CPUs in the NUMA system is synchronized using the per socket RW-spinlocks.

### BACKGROUND

Typically, a multi socket non-uniform memory access (NUMA) system includes multiple central processing units (CPUs) which may be employed to perform various computing tasks. In such an environment each computing task may be performed by one or multiple CPUs. When performing a task, a CPU may access per-CPU data of the CPU maintained by the operating system kernel in the NUMA system. In such a scenario, the CPU may need to access the per-CPU data of the CPU independent of other CPUs and/or may need to access the per-CPU data of all the CPUs in the NUMA system.

### BRIEF DESCRIPTION OF THE DRAWINGS

FIG. 1 illustrates an example non-uniform memory access (NUMA) system;

FIG. 2 is an example block diagram illustrating data structures involved in synchronizing per-CPU data access using per socket reader-writer spinlocks (RW-spinlocks) in the NUMA system shown in FIG. 1;

FIG. 3 illustrates a flowchart of an example method for synchronizing per-CPU data access using per socket RW-spinlocks in a NUMA system; and

FIG. 4 illustrates another flowchart of an example method for synchronizing per-CPU data access using per socket RW-spinlocks in a NUMA system.

The drawings described herein are for illustration and are not intended to limit the scope of the present disclosure in any way.

### DETAILED DESCRIPTION

In the following detailed description of the examples of the present subject matter, references are made to the accompanying drawings that form a part hereof, and in which are shown by way of illustration specific examples in which the present subject matter may be practiced. These examples are described in sufficient detail to enable those skilled in the art to practice the present subject matter, and it is to be understood that other examples may be utilized and that changes may be made without departing from the scope of the present subject matter. The following detailed description is, therefore, not to be taken in a limiting sense, and the scope of the present subject matter is defined by the appended claims.

For accessing such per-CPU data, a spinlock is provided for each CPU to synchronize access to per-SPU data of the CPU. In this scenario, when a CPU needs to access per-CPU data of the CPU independent of other CPUs, the CPU obtains the associated spinlock and releases the spinlock after the operation. Further, when multiple CPUs need to be synchronized for accessing the per-CPU data of ail CPUs, the spinlocks of all the CPUs are obtained for accessing the per-CPU data and released after the operation. However, performing synchronization using this method may not be scalable as the number of spinlocks that need to be obtained for synchronization is equal to the number of CPUs, and this linearly increases with increased number of CPUs. For large non-uniform memory access (NUMA) systems, the number of spinlocks that need to be obtained may be high. In an example scenario, the number of spinlocks that need to be obtained using this method in a large NUMA system with 512 CPUs is 512. Also, the synchronization operation may be time consuming due to the large number of spinlocks that need to be obtained.

Alternatively for accessing such per-CPU data, a single global Made Writer spinlock (RW-spinlock) is shared among all the CPUs. In this scenario, when a CPU needs to access per-CPU data of the CPU independent of other CPUs, the global RW-spinlock is acquired in a read mode. Further, When multiple CPUs need to be synchronized for accessing the per-CPU data of all CPUs, the global RW-spinlock is acquired in a write mode. However, this may need readers and writers to contend for one global RW-spinlock for accessing the per-CPU data and may end up producing memory contention delays due to cache line bouncing of the RW-spinlock between CPU caches.

The techniques described below provide a synchronization module to allocate a RW-spinlock for each of a plurality of sockets in a corresponding socket local memory (SLM). Further, the synchronization module synchronizes per-CPU data access between multiple CPUs in the NUMA system using per socket reader-writer spinlocks (RW-spinlocks). The term “per-CPU data” is used herein to refer to data associated with a CPU which can be accessed independently at some points in time, but which need all CPUs to be synchronized at other points in time for accessing the corresponding data.

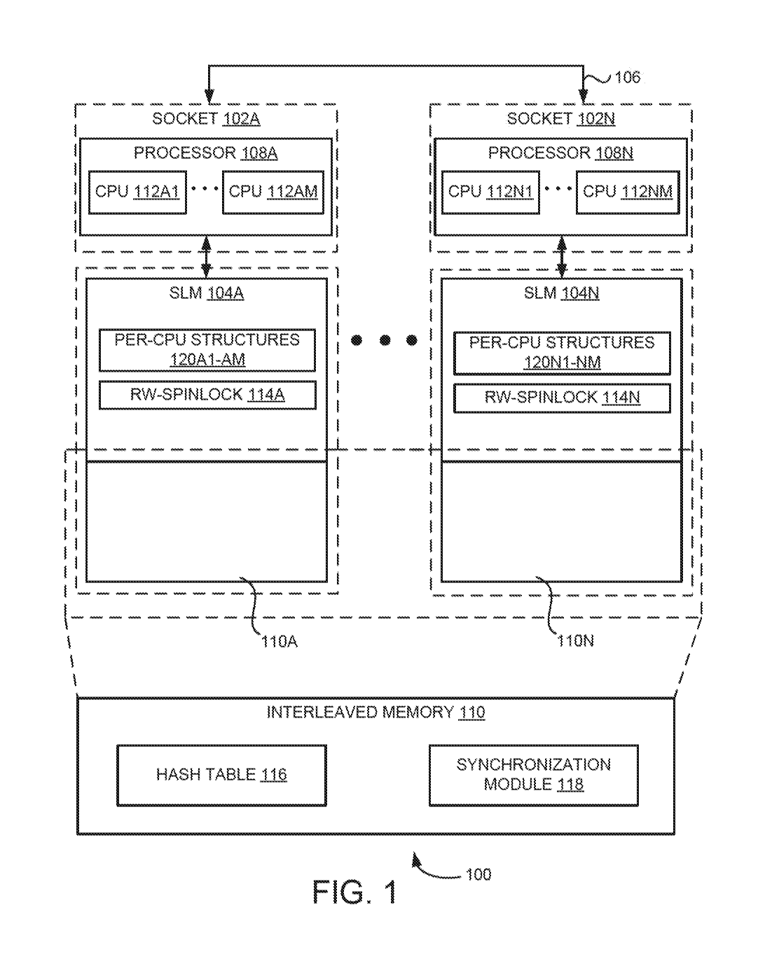

FIG. 1 illustrates an example NUMA system 100. For example, the NUMA system 100 is a multiprocessor system where memory access time is based on location or distance of a corresponding memory from a processor. As shown in FIG. 1, the NUMA system 100 includes a plurality of sockets 102A-N communicatively coupled via a bus 106. Example socket includes a processor socket. In the example shown in FIG. 1, the sockets 102A-N include processors 108A-N, respectively, and the processors 108A-N are communicatively coupled to associated socket local memories (SLMs) 104A-N. The term “processor” refers to a physical computing chip containing one or multiple CPUs. In this example, the processor can access a local memory faster compared to accessing a non-local memory. The tern “SLIM” refers to a physical memory associated with a given socket.

Furthermore, the processors 108A-N include CPUs 112A1-AM to CPUs 112N1-NM, respectively, The term “CPU” refers to a logical CPU (e.g., a hyper-thread) when hyper-threading is enabled and refers to a physical CPU (e.g., a processing core) when the hyper-threading is disabled. In addition, the SLMs 104A-N include per-CPU structures 120A1-AM to 120N1-NM, associated with the CPUs 112A1-AM to CPUs 112N1-NM, respectively. In an example scenario, for each of the CPUs 112A1-AM to CPUs 112N1-NM in the system 100, an operating system allocates a per-CPU structure in the corresponding SLM. The per-CPU structure of a given CPU is accessed in a fast means through, a special register that stores a handle to this per-CPU structure. Moreover, the SLMs 104A-N include portions of interleaved memory 110A-N. Further, the interleaved memory 110, formed by the portions of interleaved memory 110A-N, includes a hash table 116 and a synchronization module 118.

in operation, the synchronization module 118 identifies a number of sockets (L) in the NUMA system 100 using fabric services that provide information about the underlying hardware. The synchronization module 118 then allocates and maintains the hash table 116 with L entries in the interleaved memory 110. Further, the synchronization module 118 initializes each entry in the hash table 116 with a corresponding socket identifier (ID) and a number of CPUs in the socket. For example, a socket ID is a unique ID assigned to a socket.

Furthermore, the synchronization module 118 allocates RW-spinlocks 114A-N for the sockets 102A-N, respectively, in the corresponding SLMs 104A-N by passing appropriate information and flags to a virtual memory subsystem, and initializes the RW-spinlocks 114A-N. In an example scenario, passing the appropriate information and flags include passing flags to indicate that the allocation should be made in the SLIM, size of memory to be allocated, and other parameters needed by the virtual memory subsystem. A RW-spinlock may refer to a reader-writer spinlock which is a non-blocking synchronization primitive provided by an operating system kernel that allows multiple readers or a single writer to acquire the spinlock. In an example implementation, during system startup, the synchronization module 118 queries the underlying hardware about the underlying sockets and the CPUs associated with the sockets. The synchronization module 118 then uses this information to allocate and initialize the RW-spinlocks 114A-N and to fill the hash table 116.

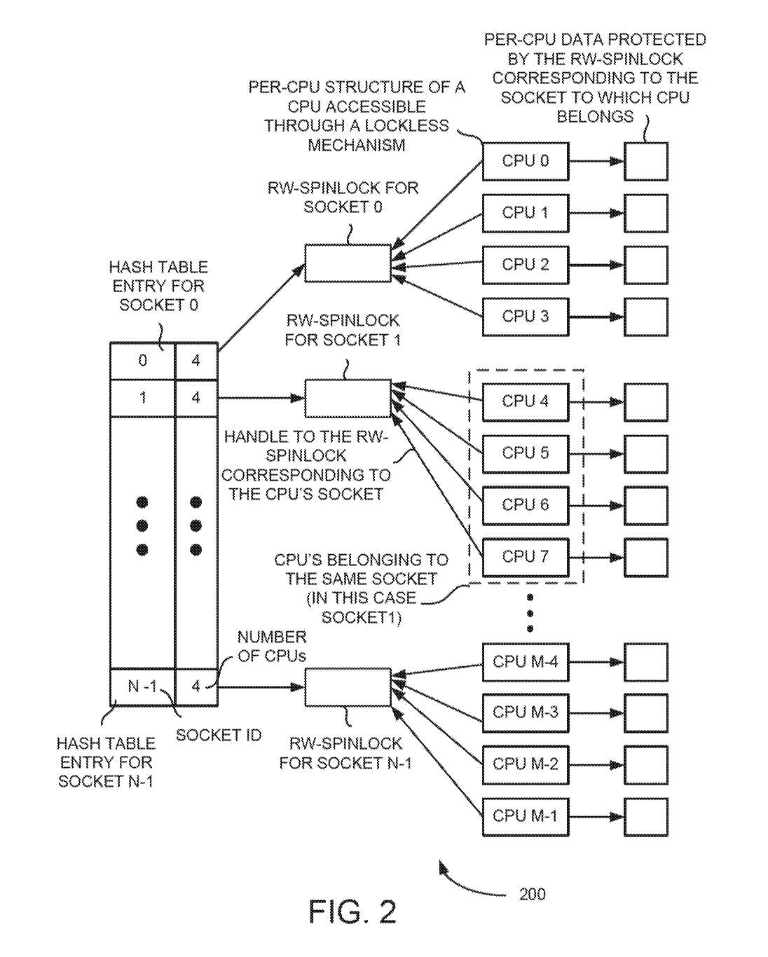

In addition, the synchronization module 118 stores a handle (e.g., a pointer indicated by an arrow in FIG. 2) to each of the per socket RW-spinlocks 114A-N in the associated hash table entry and in the per-CPU structures 120A1-AM to 120N1-NM of the associated CPUs 112A1-AM to CPUs 112N1-NM. In other words, the hash table 116 is indexed using the socket ID so that each hash table entry points to the RW-spinlock of the corresponding socket. In some processor architectures, a per socket RW-spinlock is cached in the shared last level cache (LLC) of a processor thus enabling all CPUs in the socket to access it without additional cache pre-fetch operations. The data structures involved in synchronizing per-CPU data access using per socket RW-spinlocks 114A-N in the NUMA system 100 are shown in FIG. 1 In the block diagram 200, socket 0 to socket N-1 may include sockets 102A-N. Also, CPU 0 to CPU 3 may include CPUs 112A1-AM, CPU 4 to CPU 7 may include CPUs 11261-BM and CPU M-4 to CPU M-1 n ay include CPUs 112N1-NM.

Moreover, the synchronization module 118 synchronizes per-CPU data access between the CPUs 112A1-AM to CPUs 112N1-NM using the RW-spinlocks 114A-N associated with the sockets 102A-N. In an example scenario, the synchronization module 118 synchronizes per-CPU data access between the multiple CPUs 112A1-AM to CPUs 112N1-NM such that one CPU can access the per-CPU data at any given time. For example, the per-CPU data of each CPU is maintained by the operating system kernel in the NUMA system 100. Example per-CPU data includes per-CPU accounting information, kernel event trace buffers, and the like.

In an example implementation, the synchronization module 118 determines whether a CPU (e.g., CPU 112A1) needs to access the per-CPU data of all CPUs 112A1-AM to CPUs 112N1-NM. Further in this example implementation, the synchronization module 118 configures the CPU 112A1 to Obtain the per socket RW-spinlocks 114A-N, respectively in a write mode from the associated SLMs 104A-N by iterating over the hash table 116, if the CPU 112A1 needs to access the per-CPU data of all CPUs 112A1-AM to CPUs 112N1-NM. The synchronization module 118 then configures the SPU 112A1 to access the per-CPU data of all CPUs 112A1-AM to CPUs 112N1-NM. The CPU 112A1 then releases the per socket RW-spinlocks 114A-N.

Furthermore in this example implementation, the synchronization module 118 configures the CPU 112A1 to obtain the per socket RW-spinlock 114A in a read mode from the associated SLM 104A, if the CPU 112A1 needs to independently access per-CPU data of the CPU. In an example, the CPU 112A1 obtains the per socket RW-spinlock 114A by using the handle in the per-CPU structure 120A1 of the CPU 112A1 which is accessible through a luckless mechanism. In some serve scenarios, the CPU 112A1 can access the RW-spinlock 114A for the socket 102A using the hash table 116 or through the handle to the RW-spinlock 114A that is available through the per-CPU structure 120A1 which is accessible through the lockless mechanism. In this example, the CPU 112A1 and remaining CPUs 112A2-AM in the socket 102A can obtain the per socket RW-spinlock 114A in the read mode and can independently access their per-CPU data in parallel.

In the discussion herein, the synchronization module 118 has been described as a combination of circuitry and executable instructions. Such components can be implemented in a number of fashions. Looking at FIG. 1, the executable instructions can be processor executable instructions, such as program instructions, stored on a memory resource, which is a tangible, non-transitory computer readable storage medium, and the circuitry can be electronic circuitry for executing those instructions.

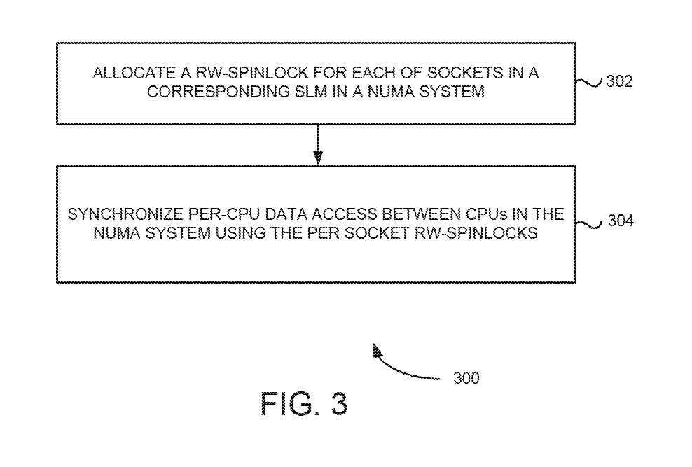

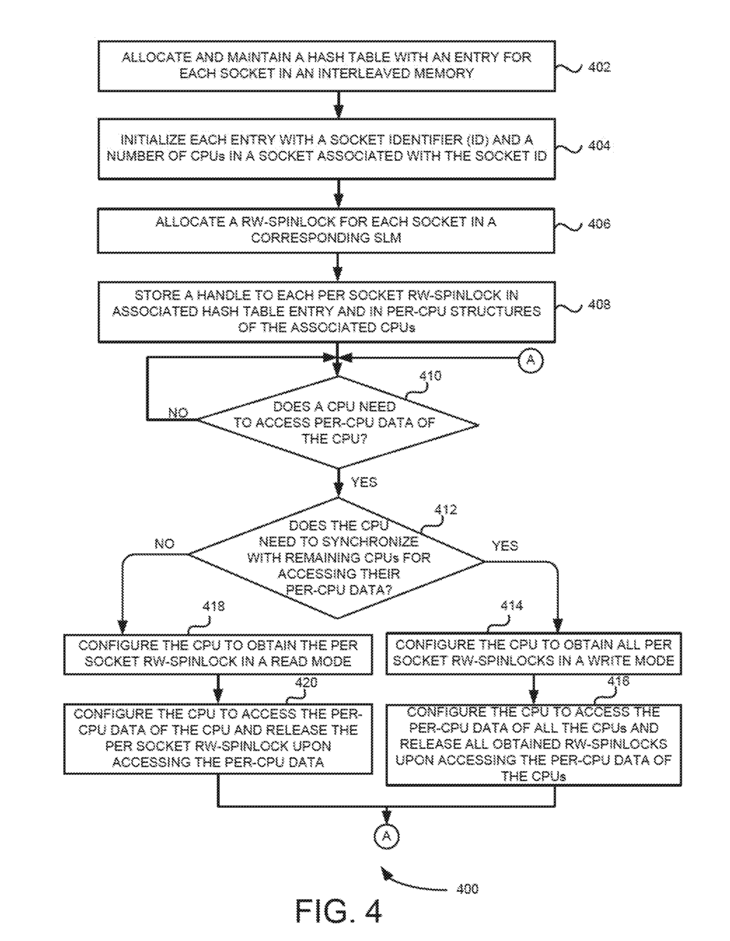

Referring now to FIG. 3, which is a flow hart 300 of an example method for synchronizing per-CPU data access using per socket RW spinlocks in a NUMA system. At block 302, a RW-spinlock is allocated for each socket in a corresponding SLM. For example, a socket includes one or multiple CPUs and the CPUs are communicatively coupled to the corresponding SLM. At block 304, per-CPU data access between the CPUs in the NUMA system is synchronized using the allocated per socket RW-spinlocks. For example, the per-CPU data of each CPU is maintained by an operating system kernel in the NUMA system. Example per-CPU data includes per-CPU accounting information, kernel event trace buffers, and the like. This is explained in more detail with reference to FIG. 4.

Referring now to FIG. 4, which is another flowchart 400 of an example method for synchronizing per-CPU data access using per socket RW-spinlocks in a NUMA system. FIG. 4 illustrates synchronizing the per-CPU data access using the per socket RW-spinlocks in the NUMA system that may be performed by, for example, a synchronization module residing in an interleaved memory described above. At block 402, a hash table with an entry for each socket is allocated and maintained in the interleaved memory. In an example each socket includes one or multiple CPUs and the CPUs are communicatively coupled to a corresponding SLM. At block 404, each entry in the hash table is initialized with a socket identifier (ID) and a number of CPUs in a socket associated with the socket ID. At block 406, a RW-spinlock is allocated for each socket in the corresponding SLM. A RW-spinlock may refer to a reader-writer spinlock which is a non-blocking synchronization primitive provided by an operating system kernel that allows multiple readers or a single writer to acquire the lock. At block 408, a handle to each per socket RW-spinlock is stored in an associated hash table entry and in per-CPU structures of associated CPUs that can be accessed in a lockless mechanism.

At block 410, a check is made to determine whether a CPU in the NUMA system needs to access per-CPU data of the CPU. Further, the step of determining whether the CPU needs to access per-CPU data of the CPU is repeated, if the CPU does not need to access per-CPU data of the CPU. At block 412, a check is made to determine whether the CPU needs to synchronize with remaining CPUs for accessing their per-CPU data, if the CPU needs to access per-CPU data of the CPU. At block 414, the CPU is to obtain the RW-spinlocks of all sockets in a write mode by iterating over the hash table, if the CPU needs to synchronize with the remaining CPUs for accessing their per-CPU data. At block 416, the CPU is to access the per-CPU data of all CPUs and then release the obtained per socket RW-spinlocks. Further, the process steps from block 410 are repeated. At block 418, the CPU is to obtain the per socket RW-spinlock associated with the CPU using the handle to the RW-spinlock stored in the associated per-CPU structure in a read mode, if the CPU needs to access per-CPU data of the CPU independently of the remaining CPUs. At block 420, the CPU is to access the per-CPU data and release the RW-spinlock upon accessing the per-CPU data. Further, the process steps from block 410 are repeated.

In addition, it is be appreciated that the various operations, processes, and methods disclosed herein may be embodied in a machine-readable medium and/or a machine accessible medium compatible with a computer system and may be performed in any order (e.g., including using means for achieving the various operations). Accordingly, the specification and drawings are to be regarded in an illustrative rather than a restrictive sense.

In various examples, and methods described in FIGS. 1 through 4 propose a technique to synchronize per-CPU data using per socket RW-spinlocks. In this technique, a RW-spinlock is allocated for ach socket the corresponding KM thus allowing all CPUs of the given processor to access the RW-spinlock with low latency. Further this technique is scalable as one additional RW-spinlock needs to be allocated, if a new socket that contains one or multiple CPUs is added to the system.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally under the doctrine of equivalents.

What is claimed is:

1. A method comprising:
allocating a reader-writer spinlock (RW-spinlock) for each socket in a corresponding socket local memory (SLM) in a non-uniform memory access (NUMA) system, wherein each socket comprises at least one central processing unit (CPU) and wherein the at least one CPU in each socket is communicatively coupled to the corresponding SLM; and
synchronizing per-CPU data access between the CPUs in the NUMA system using the per socket RW-spinlocks.

2. The method of claim 1, wherein synchronizing per-CPU data access between the CPUs in the NUMA system using the per socket RW-spinlocks, comprises:
determining whether a CPU in the NUMA system needs to access the per-CPU data of the CPU and at least one of remaining CPUs;
if so, configuring the CPU to obtain the per socket RW-spinlocks associated with the CPU and the at least one of remaining CPUs in a write mode; and
configuring the CPU to access the per-CPU data of the CPU and the at least one of remaining CPUs and release the obtained per socket RW-spinlocks upon accessing the per-CPU data of the CPU and the at least one of remaining CPUs.

3. The method of claim 2, further comprising:
configuring the CPU to obtain the per socket RW-spinlock associated with the CPU in a read mode, if the CPU needs to independently access the per-CPU data of the CPU; and
configuring the CPU to access the per-CPU data of the CPU and release the obtained per socket RW-spinlock upon accessing the per-CPU data of the CPU.

4. The method of claim 1, further comprising:
allocating and maintaining a hash table with an entry for each socket; and
initializing each entry With a socket identifier (ID) and a number of CPUs in a socket associated with the socket ID.

5. The method of claim 4, further comprising:
storing a handle to each per socket RW-spinlock in an associated hash table entry.

6. The method of claim 1, further comprising:
storing a handle to each per socket RW-spinlock in a per-CPU structure of the at least one CPU of the corresponding socket.

7. A non-uniform memory access (NUMA) system comprising:
a plurality of sockets, wherein each socket comprises at least one central processing unit (CPU), wherein the at least one CPU in each socket is communicatively coupled to an associated socket local memory (SLM), wherein each SLM includes a portion of an interleaved memory and wherein the interleaved memory comprises synchronization module to:
allocate a reader-writer (RW) spinlock for each of the plurality of sockets in the associated SLM; and
synchronize per-CPU data access between the CPUs in the NUMA system using the per socket RW-spinlocks.

8. The NUMA system of claim 7, wherein the synchronization module is to:
determine whether a CPU in the NUMA system needs to access the per-CPU data of the CPU and at least one of remaining CPUs;
if so, configure the CPU to obtain the per socket RW-spinlocks associated with the CPU and the at least one of remaining CPUs in a write mode; and
configure the CPU to access the per-CPU data of the CPU and the at least one of remaining CPUs and release the obtained per socket RW-spinlocks upon accessing the per-CPU data of the CPU and the at least one of remaining CPUs.

9. The NUMA system of claim 8, wherein the synchronization module is further to:
configure the CPU to obtain the per socket RW-spinlock associated with the CPU in a read mode, if the CPU needs to independently access the per-CPU data of the CPU; and
configure the CPU to access the per-CPU data of the CPU and release the obtained per socket RW-spinlock upon accessing the per-CPU data of the CPU.

10. The NUMA system of claim 7, wherein the synchronization module is further to:
allocate and maintain a hash table with an entry for each of the plurality of sockets; and
initialize each entry with a socket identifier (ID) and a number of CPUs in a socket associated with the socket ID.

11. The NUM system of claim 10, wherein the synchronization module is further to:
store a handle to each per socket RW-spinlock in an associated hash table entry.

12. The NUMA system of claim 7, wherein the synchronization module is further to:
store a handle to each per socket RW-spinlock in a per-CPU structure of the at least one CPU of the corresponding socket.

13. A non-transitory comp readable storage medium comprising a set of instructions executable by a processor resource to:
allocate a reader-writer spinlock (RW-spinlock) for each socket in a corresponding socket local memory (SLM) in a non-uniform memory access (NUMA) system, wherein each socket comprises at least one central processing unit (CPU) and wherein the at least one CPU in each socket is communicatively coupled to the corresponding SLM; and
synchronize per-CPU data access between the CPUs in the NUMA system using the per socket RW-spinlocks.

14. The non-transitory computer readable storage medium of claim 13, wherein the set of instructions is to:
determine whether a CPU in the NUMA system needs to access the per-CPU data of the CPU and at least one of remaining CPUs;
if so, configure the CPU to obtain the per socket RW-spinlocks associated with the CPU and the at least one of remaining CPUs in a write mode; and
configure the CPU to access the per-CPU data of the CPU and the at least one of remaining CPUs and release the obtained per socket RW-spinlocks upon accessing the per-CPU data of the CPU and the at least one of remaining CPUs.

15. The non-transitory computer readable storage medium of claim 14, wherein the set of instructions is further to:
configure the CPU to obtain the per socket RW-spinlock associated with the CPU in a read mode, if the CPU needs to independently access the per-CPU data of the CPU; and
configure the CPU to access the per-CPU data of the CPU and release the obtained per socket RW-spinlock upon accessing the per-CPU data of the CPU.
